(19) United States
(12) Patent Application Publication
(10) Pub. No.: US 2025/0052018 A1
(43) Pub. Date: Feb. 13, 2025

(54) ROAD SURFACE MARKING DETERIORATION ANALYSIS APPARATUS, METHOD, AND COMPUTER-READABLE MEDIUM

(71) Applicant: NEC CORPORATION, Minato-ku, Tokyo (JP)

(72) Inventors: Masanori KUKI, Tokyo (JP); Shintaro Chiku, Tokyo (JP); Naoko Fukushi, Tokyo (JP); Shuei Yamada, Tokyo (JP); Shuhei Mizuguchi, Tokyo (JP); Kosei Kobayashi, Tokyo (JP)

(73) Assignee: NEC CORPORATION, Minato-ku, Tokyo (JP)

(21) Appl. No.: 18/722,835

(22) PCT Filed: Mar. 1, 2022
(86) PCT No.: PCT/JP2022/008588

§ 371 Date: Jun. 21, 2024

(51) Int. Cl. E01C 23/01; G01S 17/89; G06V 20/56

(52) U.S. Cl. CPC E01C 23/01; G01S 17/89; G06V 20/588

(57) ABSTRACT

A road surface marking detection means detects a road surface marking on a road, based on sensor information acquired by sensing a road. An interruption detection means detects a portion where the road surface marking is interrupted, based on a detection result of the road surface marking. A factor determination unit determines a factor for which the road surface marking is interrupted with respect to a portion where a matter that the road surface marking is interrupted is detected.

### TECHNICAL FIELD The present disclosure relates to a road surface marking deterioration analysis apparatus, a method, and a computer-readable medium.

### BACKGROUND ART

As a related art, Patent Literature 1 discloses a road marking body deterioration detection apparatus. The road marking body deterioration detection apparatus acquires a camera image in which a pedestrian crossing is captured from an obliquely upper side from a camera. The road marking body deterioration detection apparatus trims an area of the pedestrian crossing from the acquired camera image. The road marking body deterioration detection apparatus corrects the trimmed image of the area of the pedestrian crossing into a bird's eye view by using homography conversion. The road marking body deterioration detection apparatus calculates a peeling rate of a white line in the pedestrian crossing from the corrected bird's-eye view-like image being corrected, and determines whether a white line area is deteriorated in the pedestrian crossing.

### CITATION LIST

### Patent Literature

Patent Literature 1: Japanese Unexamined Patent Application Publication No. 2017-020303

### SUMMARY OF INVENTION

### Technical Problem

In Patent Literature 1, a peeling rate of a white line is calculated according to a ratio of “white” and “black” in an area of the white line, and it is determined that the white line is deteriorated when the peeling rate is high. However, in Patent Literature 1, even when the white line is not actually deteriorated, it is determined that the white line is deteriorated in a field having a large ratio of “black” in an image. In this case, there is a possibility that a user such as a road administrator may receive an erroneous determination result from the road marking body deterioration detection apparatus described in Patent Literature 1, and a maintenance plan and a management plan of the road may be formulated based on the erroneous determination result.

In view of the above circumstances, an object of the present disclosure is to provide a road surface marking deterioration analysis apparatus being capable of providing a user such as a road administrator with information useful for maintenance and management of a road.

### Solution to Problem

In order to achieve the above object, the present disclosure provides, as a first aspect, a road surface marking deterioration analysis apparatus. The road surface marking deterioration analysis apparatus includes: a road surface marking detection means for detecting a road surface marking on a road, based on sensor information acquired by sensing a road; an interruption detection means for detecting a portion where the road surface marking is interrupted, based on a detection result of the road surface marking: and a factor determination means for determining a factor for which the road surface marking is interrupted with respect to a portion where a matter that the road surface marking is interrupted is detected.

The present disclosure provides, as a second aspect, a road surface marking deterioration analysis method. The road surface marking deterioration analysis method includes: detecting a road surface marking on a road, based on sensor information acquired by sensing a road; detecting a portion where the road surface marking is interrupted, based on a detection result of the road surface marking: and determining a factor for which the road surface marking is interrupted with respect to a portion where a matter that the road surface marking is interrupted is detected.

The present disclosure provides, as a third aspect, a computer-readable medium. The computer-readable medium stores a program for causing a computer to execute processing including: detecting a road surface marking on a road, based on sensor information acquired by sensing a road; detecting a portion where the road surface marking is interrupted, based on a detection result of the road surface marking: and determining a factor for which the road surface marking is interrupted with respect to a portion where a matter that the road surface marking is interrupted is detected.

### Advantageous Effects of Invention

A road surface marking deterioration analysis apparatus, a method, and a computer-readable medium according to the present disclosure can provide a user such as a road administrator with information useful for maintenance and management of a road.

### BRIEF DESCRIPTION OF DRAWINGS

FIG. 1 is a block diagram illustrating a schematic configuration of a road surface marking deterioration analysis apparatus according to the present disclosure;

FIG. 2 is a block diagram illustrating a road surface marking deterioration analysis system including a road surface marking deterioration analysis apparatus according to one example embodiment of the present disclosure;

FIG. 3 is a block diagram illustrating a configuration example of the road surface marking deterioration analysis apparatus;

FIG. 4 is a schematic diagram illustrating an example of a camera image in a case where a demarcation line is blurred and deteriorated;

FIG. 5 is a schematic diagram illustrating an example of a camera image in a case where a demarcation line is covered with fallen leaves;

FIG. 6 is a flowchart illustrating an operation procedure in the road surface marking deterioration analysis apparatus; and

FIG. 7 is a block diagram illustrating a configuration example of a computer apparatus.

### EXAMPLE EMBODIMENT

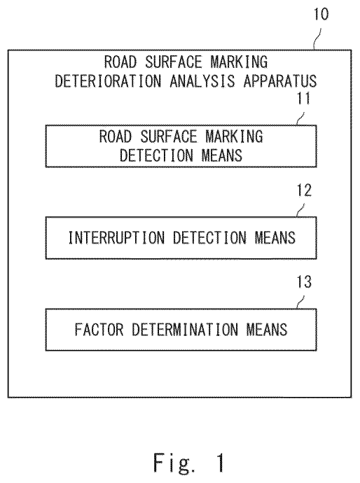

Prior to the description of an example embodiment of the present disclosure, an outline of the present disclosure will be described. FIG. 1 illustrates a schematic configuration of a road surface marking deterioration analysis apparatus according to the present disclosure. A road surface marking deterioration analysis apparatus 10 includes a road surface marking detection means 11, an interruption detection means 12, and a factor determination means 13.

The road surface marking detection means 11 detects a road surface marking on a road, based on sensor information acquired by sensing the road. The interruption detection means 12 detects a portion where the road surface marking is interrupted, based on a detection result of the road surface marking. Herein, a matter that the road surface marking is interrupted indicates, for example, a portion where presence of the road surface marking cannot be confirmed in the sensor information in a portion where the road surface marking (such as paint thereof) is to be applied originally. The factor determination means 13 determines a factor for which the road surface marking is interrupted with respect to a portion where a matter that the road surface marking is interrupted is detected.

In the present disclosure, the road surface marking deterioration analysis apparatus does not simply detect a portion where the road surface marking is interrupted as a portion where the road surface marking is deteriorated, but determines a factor thereof. A user, such as a road administrator, can refer to a factor for which the road surface marking is interrupted, and plan maintenance and management of a road according to the factor. As described above, the road surface marking deterioration analysis apparatus according to the present disclosure can provide information being useful for maintenance and management of a road to a user such as a road administrator.

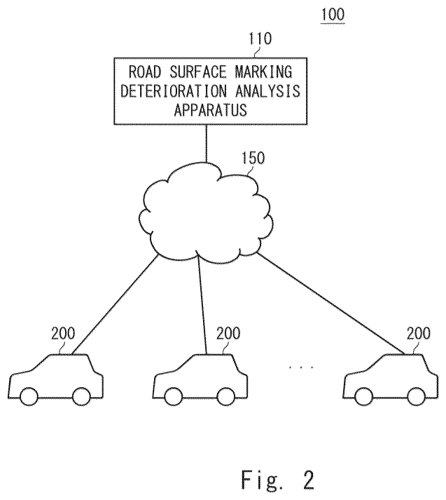

Hereinafter, an example embodiment of the present disclosure will be described in detail. FIG. 2 illustrates a road surface marking deterioration analysis system including a road surface marking deterioration analysis apparatus according to one example embodiment of the present disclosure. A road surface marking deterioration analysis system 100 includes a road surface marking deterioration analysis apparatus 110, and one or more moving bodies 200. The road surface marking deterioration analysis apparatus 110 is connected to the one or more moving bodies 200 via a network 150. The network 150 includes, for example, a wireless communication network using a communication line standard such as long term evolution (LTE). The network 150 may include a wireless communication network such as WiFi (registered trademark) or a fifth generation mobile communication system.

The moving body 200 is configured as a land vehicle traveling on a road, such as an automobile, a bus, a taxi, or a truck. The moving body 200 may be a vehicle such as a public vehicle, a garbage collection vehicle, or a police vehicle. The moving body 200 includes a surrounding monitoring sensor for monitoring a surrounding situation of the moving body. The surrounding monitoring sensor includes a sensor such as, for example, a camera light detection and ranging (LIDAR). The moving body 200 may be configured to be capable of automatic driving (autonomous driving), based on information of a sensor mounted on the moving body.

A communication apparatus is mounted on the moving body 200, and the communication apparatus transmits sensor data (sensor information) of the surrounding monitoring sensor to the road surface marking deterioration analysis apparatus 110. For example, the moving body 200 transmits a camera image captured by a camera, three-dimensional point cloud data acquired by a LiDAR, or both thereof, as sensor data to the road surface marking deterioration analysis apparatus 110. Hereinafter, an example in which the moving body 200 includes a camera and transmits a camera image to the road surface marking deterioration analysis apparatus 110 will be mainly described. Each moving body 200 may include a plurality of cameras that capture a front side, a rear side, a right side, and a left side of a vehicle.

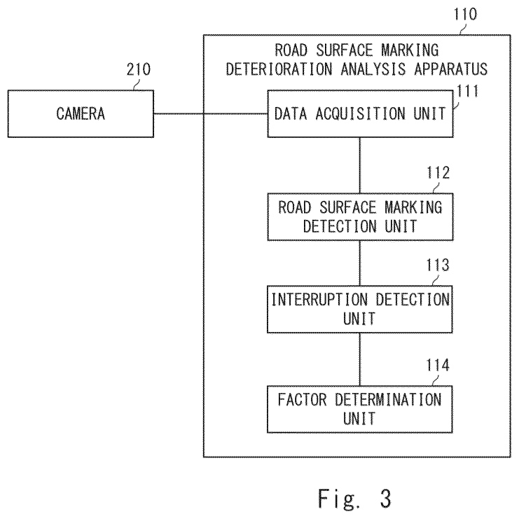

The road surface marking deterioration analysis apparatus 110 analyzes deterioration of a road surface marking on a road by using the sensor data transmitted from the moving body 200. FIG. 3 illustrates a configuration example of the road surface marking deterioration analysis apparatus 110. The road surface marking deterioration analysis apparatus 110 includes a data acquisition unit 111, a road surface marking detection unit 112, an interruption detection unit 113, and a factor determination unit 114. The road surface marking deterioration analysis apparatus 110 is configured as a computer apparatus having, for example, one or more memories and one or more processors.

At least a part of a function of each unit in the road surface marking deterioration analysis apparatus 110 may be achieved by the processor operating according to a program being read from the memory. The road surface marking deterioration analysis apparatus 110 corresponds to the road surface marking deterioration analysis apparatus 10 illustrated in FIG. 1.

The data acquisition unit 111 acquires a camera image from a camera 210. The camera 210 is mounted on the moving body 200 (see FIG. 2). In the present example embodiment, the camera 210 only needs to transmit a camera image acquired by capturing a road to the road surface marking deterioration analysis apparatus 110, and it is not necessarily required to be mounted on the moving body 200. The camera 210 may be installed in a traffic light or a roadside unit. The data acquisition unit 111 may acquire three-dimensional point cloud data (a LiDAR image) including data of an area of a road from a 3D scanner such as LiDAR, instead of or in addition to a camera image.

The road surface marking detection unit 112 detects a road surface marking (area thereof) on a road from a camera image of the camera 210. The road surface marking detection unit 112 detects, for example, a demarcation line on a road. The demarcation line can be detected by, for example, searching for a painted area having a predetermined color (for example, white) in a camera image. The road surface marking detection unit 112 corresponds to the road surface marking detection means 11 illustrated in FIG. 1.

The interruption detection unit 113 detects, based on a camera image, a portion where a demarcation line is interrupted in the demarcation line detected by the road surface marking detection unit 112. In other words, the interruption detection unit 113 detects a portion where deterioration has occurred apparently in the demarcation line. The interruption detection unit 113 detects, for example, a portion where the demarcation line is interrupted in a camera image, that is, a portion where there is no demarcation line at a position where the demarcation line is to be present originally, as a portion where deterioration has occurred. The interruption detection unit 113 may determine a portion where the demarcation line is interrupted by comparing with past data. Herein, the past data mean data acquired before a time point at which a camera image is acquired. The past data include, for example, at least one of a construction record of construction on the road, inspection data of the road, and a detection result of the road surface marking in past. For example, the interruption detection unit 113 collates the demarcation line detected by the road surface marking detection unit 112 with a construction register (construction record) of construction or past inspection data, and determines a portion where the demarcation line is interrupted. The construction register of the construction or the past inspection data may be acquired from, for example, a database owned by a road administrator. The interruption detection unit 113 may determine a portion where the demarcation line is interrupted by collating a detection result of the demarcation line in the road surface marking detection unit 112 with a detection result of the demarcation line detected in the past by the road surface marking detection unit 112. A portion where deterioration has occurred detected by the interruption detection unit 113 may include a portion where deterioration has actually occurred in the road surface marking, and a portion where it appears that deterioration has occurred in a camera image but deterioration has not actually occurred. The interruption detection unit 113 corresponds to the interruption detection means 12 illustrated in FIG. 1.

The factor determination unit 114 determines a factor of a portion where the road surface marking is interrupted detected by the interruption detection unit 113. The factor determination unit 114 determines, for example, whether a factor for which a road surface marking is interrupted is deterioration of the road surface marking or dirt of the road surface marking. For example, the factor determination unit 114 determines a factor for which the demarcation line is not visible, for example, in a case where the demarcation line is not visible in a camera image. Specifically, the factor determination unit 114 determines whether the demarcation line is simply not visible in the camera image, or whether the demarcation line is blurred and not visible. The factor determination unit 114 may determine a factor for which the road surface marking is interrupted, for example, based on a camera image.

The factor determination unit 114 outputs information indicating a portion where the road surface marking is interrupted and a result of determination at the portion. The factor determination unit 114 displays, for example, on a screen of a display apparatus, a portion where a matter that the demarcation line is interrupted is detected and a factor of the interruption in the portion. The factor determination unit 114 corresponds to the factor determination means 13 illustrated in FIG. 1.

Various types of information may be used to determine a factor for which the road surface marking is interrupted. The factor determination unit 114 may, for example, acquire cleaning information on a road, and determine a factor by using the acquired cleaning information. The cleaning information includes, for example, information indicating when cleaning of the road is performed, that is, information indicating a cleaning date. The factor determination unit 114 may compare an acquisition date of a camera image with the cleaning date, and determine a factor of the interruption, based on a comparison result. The factor determination unit 114 determines, for example, a factor for which the road surface marking is interrupted according to a difference between the acquisition date of the camera image and the cleaning date, that is, the number of days elapsed since the latest cleaning date.

For example, when the acquisition date of a camera image is immediately after the cleaning date, it is conceivable that there is a low possibility that a fallen leaf or another attached object is attached to the demarcation line. In this case, the factor determination unit 114 determines that a reason why the demarcation line is interrupted in the camera image and a matter that the demarcation line is interrupted is detected in the interruption detection unit 113 is that the demarcation line is actually blurred or the like and thereby deteriorated. On the other hand, when the number of days elapsed from the latest cleaning date is equal to or more than a certain number, it is conceivable that the road surface is dirty due to a fallen leaf, garbage, or the like, and the demarcation line is interrupted in the camera image. In this case, the factor determination unit 114 determines that detecting, in the interruption detection unit 113, a matter that the demarcation line is interrupted is due to covering the demarcation line with a fallen leaf or garbage.

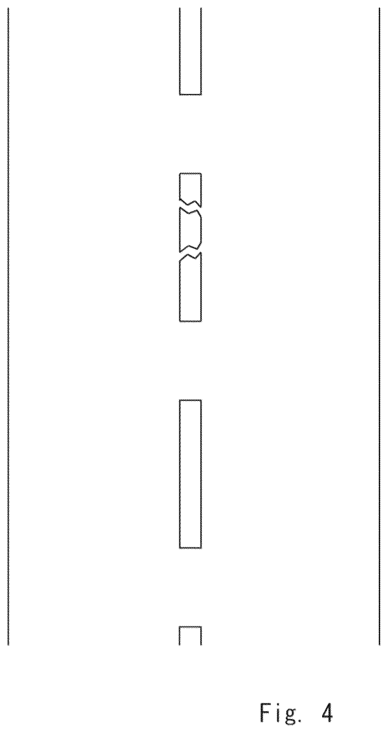

FIG. 4 illustrates an example of a camera image in a case where a demarcation line is blurred and deteriorated. In the example in FIG. 4, paint is blurred in a part of the demarcation line in a center of the road. The interruption detection unit 113 detects, as a deteriorated portion, a portion where the demarcation line is interrupted in the camera image. For example, when the camera image is a camera image captured immediately after the cleaning date, the factor determination unit 114 determines that the demarcation line is actually deteriorated.

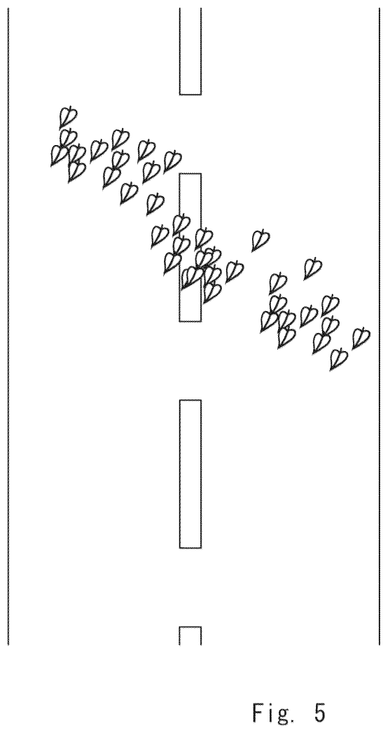

FIG. 5 illustrates an example of a camera image in a case where a demarcation line is covered with fallen leaves. In the example in FIG. 5, paint is covered with fallen leaves in a part of the demarcation line in the center of the road. In this case, the interruption detection unit 113 detects, as the deteriorated portion, a portion where the demarcation line is interrupted in the camera image. For example, when the camera image is a camera image captured after a predetermined number of days from the cleaning date, the factor determination unit 114 determines that the demarcation line is not actually deteriorated and the demarcation line is dirty.

The factor determination unit 114 may determine presence or absence of a fallen leaf, garbage, or the like on the road, based on a camera image, and determine that the demarcation line is actually deteriorated when there is no fallen leaf or garbage on the road. When there is a fallen leaf or garbage on the road, the factor determination unit 114 may determine that the demarcation line is dirty.

The factor determination unit 114 may acquire maintenance information indicating a maintenance situation of the road surface marking on the road, and determine a factor for which the road surface marking is interrupted by using the acquired maintenance information. The maintenance information includes information indicating when the road surface marking is maintained. The maintenance information may be acquired from a database managed by a road administrator, for example. The factor determination unit 114 compares a date when a camera image is acquired with a date when the road surface marking is maintained, and determines a factor, based on a result of the comparison. For example, the factor determination unit 114 determines that the road surface marking has deteriorated when the acquisition date of a camera image has elapsed for equal to or more than a predetermined number of days from a date when the road surface marking was last maintained. The factor determination unit 114 determines that the road surface marking is dirty when the acquisition date of the camera image has not elapsed for equal to or more than a predetermined number of days from the date when the road surface marking was last maintained.

The factor determination unit 114 may acquire road surface state information indicating a road surface state (a road surface condition) of the road, and determine a factor for which the road surface marking is interrupted by using the acquired road surface state information. The road surface state information can be acquired from, for example, a database managed by a road administrator.

The road surface state information includes, for example, information indicating presence or absence of a crack in the road surface, presence or absence of a pothole, or the like. The factor determination unit 114 determines a factor for which the road marking is interrupted, based on, for example, a road surface state within a predetermined distance range from a point at which the camera image is acquired. The factor determination unit 114 determines, for example, whether there are many portions where the road surface is deteriorated at a point at which the camera image is captured and in a range within a predetermined distance from the point. When the factor determination unit 114 determines that there are many portions where the road surface is deteriorated, it may determine that the demarcation line is actually deteriorated. When the factor determination unit 114 determines that there are few portions where the road surface is deteriorated, it may determine that the demarcation line is dirty.

The factor determination unit 114 may determine a factor for which the road surface marking is interrupted in consideration of a date when a camera image is acquired. For example, the factor determination unit 114 determines a season from the date when a camera image is acquired. The factor determination unit 114 may determine that the demarcation line is dirty when a season is a season with many fallen leaves, for example, autumn.

Further, the factor determination unit 114 may acquire information related to a garbage collection date, and determine a factor for which the road surface marking is interrupted by using the acquired information related to the garbage collection date. The factor determination unit 114 acquires, for example, a date and time of garbage collection. The information related to the garbage collection date may be acquired from, for example, a municipality or the like that performs garbage collection. The factor determination unit 114 determines whether a camera image is a camera image before garbage collection or a camera image after garbage collection. The factor determination unit 114 determines whether the date when a camera image is acquired is the day of the garbage collection date, and whether a time when the camera image is acquired is before or after the garbage collection. When the camera image is an image captured on the garbage collection date and before garbage collection, there is a possibility that a crow or the like ravage a garbage collection site and garbage is scattered on the road. The factor determination unit 114 may determine that the demarcation line is dirty when a camera image is an image captured on the garbage collection date and before the garbage collection. The factor determination unit 114 may determine that the demarcation line is deteriorated when a camera image is an image captured on not the garbage collection date or after the garbage collection.

When an LiDAR image (three-dimensional point cloud data) is acquired by the data acquisition unit 111, the factor determination unit 114 may determine a factor for which the road surface marking is interrupted by using the three-dimensional point cloud data. For example, the factor determination unit 114 detects a thickness of a white line portion with respect to the road surface of the road. When the thickness of the white line portion is smaller than a predetermined value, the factor determination unit 114 determines that the road surface marking is deteriorated and blurred. The factor determination unit 114 may detect an attached object attaching to the road surface marking, based on the three-dimensional point cloud data. The factor determination unit 114 detects, for example, a portion raised from the road surface by an amount of the attached object. The factor determination unit 114 determines that the road surface marking is dirty when there is an attached object in a portion where the road surface marking is interrupted.

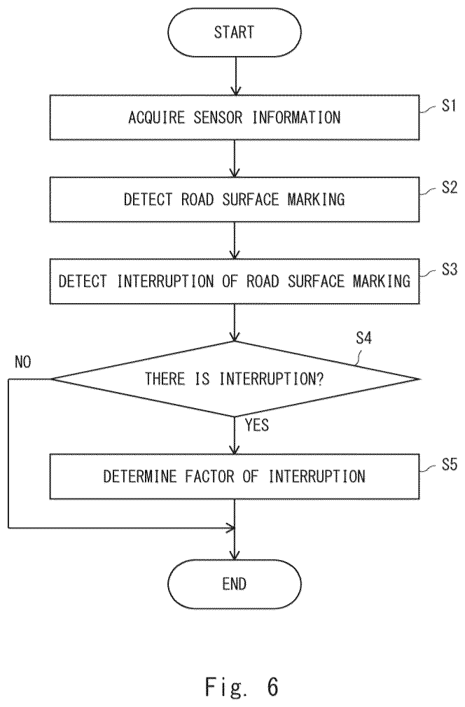

Hereinafter, an operation procedure will be described. FIG. 6 illustrates an operation procedure (road surface marking deterioration analysis method) in the road surface marking deterioration analysis apparatus 110. The data acquisition unit 111 acquires sensor information (camera image) from the camera 210 (step S1). The road surface marking detection unit 112 detects a road surface marking from the camera image (step S2). In step S2, the road surface marking detection unit 112 detects, for example, a demarcation line on the road.

The interruption detection unit 113 detects a portion where the road surface marking is interrupted (step S3). The factor determination unit 114 determines whether the road surface marking is interrupted (step S4). When determining that the road surface marking is interrupted, the factor determination unit 114 determines a factor for which the road surface marking is interrupted (step S5). In step S5, the factor determination unit 114 determines whether the demarcation line is deteriorated or the demarcation line is dirty, for example, in a portion where the demarcation line is interrupted. The factor determination unit 114 may determine a factor for which the demarcation line is interrupted by using a plurality of pieces of information. For example, the factor determination unit 114 may determine a factor for which the demarcation line is interrupted, based on a combination of two or more pieces of information among a camera image, a LiDAR image, cleaning information of the road, maintenance information of the road surface marking, road surface state information, and information related to a garbage collection date.

In the present example embodiment, the interruption detection unit 113 detects a portion where a road surface marking is interrupted from a camera image. The factor determination unit 114 determines a factor for which the road surface marking is interrupted with respect to a portion where the road surface marking is interrupted. For example, when the road surface marking is interrupted due to deterioration of the road surface marking, it is conceivable that the road surface marking needs to be maintained. On the other hand, when the road surface marking is dirty, it is only necessary to clean the road, and it is not necessary to maintain again the road surface marking. It is conceivable that determining whether the road surface marking is actually blurred and deteriorated or only dirty is important in road management. In the present example embodiment, when the interruption of the road surface marking is detected, a factor for which the road surface marking is interrupted is determined. Therefore, the road surface marking deterioration analysis apparatus 110 according to the present example embodiment can provide information being useful for road management to a user such as a road administrator.

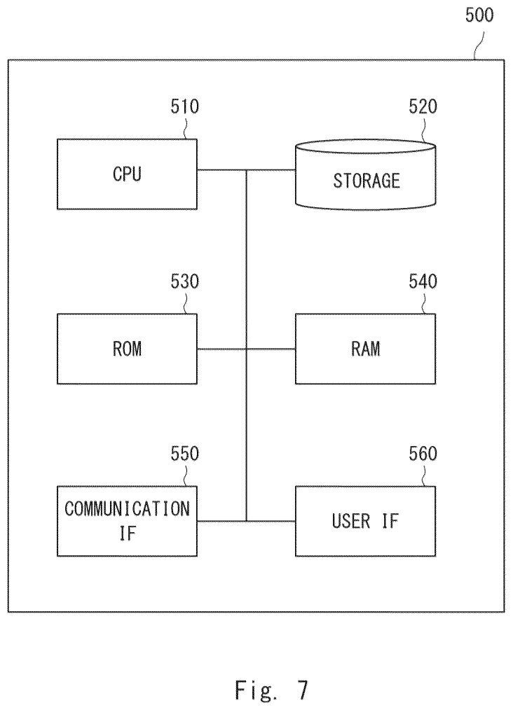

In the present disclosure, the road surface marking deterioration analysis apparatus 110 may be configured as a computer apparatus (server apparatus). FIG. 7 illustrates a configuration example of the computer apparatus that may be used as the road surface marking deterioration analysis apparatus 110. A computer apparatus 500 includes a control unit (central processing unit: CPU) 510, a storage unit 520, a read only memory (ROM) 530, a random access memory (RAM) 540, a communication interface (IF) 550, and a user interface 560.

The communication interface 550 is an interface for connecting the computer apparatus 500 and a communication network via a wired communication means, a wireless communication means, or the like. The user interface 560 includes a display unit such as a display. Further, the user interface 560 includes an input unit such as a keyboard, a mouse, and a touch panel.

The storage unit 520 is an auxiliary storage device being capable of holding various types of data. The storage unit 520 is not necessarily a part of the computer apparatus 500, and may be an external storage device, or may be a cloud storage connected to the computer apparatus 500 via a network.

The ROM 530 is a non-volatile storage device. For example, a semiconductor storage device such as a flash memory having a relatively small capacity is used for the ROM 530. A program executed by the CPU 510 may be stored in the storage unit 520 or the ROM 530. The storage unit 520 or the ROM 530 stores, for example, various programs for achieving the function of each unit in the road surface marking deterioration analysis apparatus 110.

The program includes instructions (or software code) that, when being loaded into a computer, causes the computer to perform one or more of the functions described in the example embodiment. The program may be stored in a non-transitory computer-readable medium or a tangible storage medium. By way of example, and not limitation, a computer-readable medium or a tangible storage medium includes a random-access memory (RAM), a read-only memory (ROM), a flash memory, a solid-state drive (SSD), or another memory technique, a compact disc (CD), a digital versatile disc (DVD), a Blu-ray (registered trademark) disk, or another optical disk storage, a magnetic cassette, a magnetic tape, a magnetic disk storage, or another magnetic storage device. The program may be transmitted on a transitory computer-readable medium or a communication medium. By way of example, and not limitation, a transitory computer-readable medium or a communication medium includes a propagation signal in electrical, optical, acoustic, or another form.

The RAM 540 is a volatile storage device. Various types of semiconductor memory devices such as a dynamic random access memory (DRAM) or a static random access memory (SRAM) are used for the RAM 540. The RAM 540 may be used as an internal buffer temporarily storing data and the like. The CPU 510 loads the program stored in the storage unit 520 or the ROM 530 into the RAM 540, and executes the loaded program. By executing the program by the CPU 510, the function of each unit in the road surface marking deterioration analysis apparatus 110 can be achieved. The CPU 510 may include an internal buffer being capable of temporarily storing data and the like.

While the example embodiment of the present disclosure has been described in detail above, the present disclosure is not limited to the above-described example embodiment, and changes and modifications to the above-described example embodiment without departing from the spirit of the present disclosure are also included in the present disclosure.

For example, some or all of the above-described example embodiment may be described as follows, but are not limited thereto.

### Supplementary Note 1

A road surface marking deterioration analysis apparatus including:
a road surface marking detection means for detecting a road surface marking on a road, based on sensor information acquired by sensing a road;
an interruption detection means for detecting a portion where the road surface marking is interrupted, based on a detection result of the road surface marking: and
a factor determination means for determining a factor for which the road surface marking is interrupted with respect to a portion where a matter that the road surface marking is interrupted is detected.

### Supplementary Note 2

The road surface marking deterioration analysis apparatus according to supplementary note 1, wherein
the factor determination means determines whether a factor for which the road surface marking is interrupted is deterioration of the road surface marking or dirt of the road surface marking.

### Supplementary Note 3

The road surface marking deterioration analysis apparatus according to supplementary note 1 or 2, wherein
the factor determination means determines the factor, based on the sensor information.

### Supplementary Note 4

The road surface marking deterioration analysis apparatus according to any one of supplementary notes 1 to 3, wherein
the factor determination means determines the factor by using at least one of cleaning information of the road, and maintenance information of the road surface marking on the road.

### Supplementary Note 5

The road surface marking deterioration analysis apparatus according to supplementary note 4, wherein
the factor determination means determines the factor by using cleaning information of the road, and
the factor determination means compares a date when the sensor information is acquired with a date when the road is cleaned, and determines the factor, based on a result of the comparison.

### Supplementary Note 6

The road surface marking deterioration analysis apparatus according to supplementary note 4 or 5, wherein
the factor determination means determines the factor by using maintenance information of the road surface marking, and
the factor determination means compares a date when the sensor information is acquired with a date when the road surface marking is maintained, and determines the factor, based on a result of the comparison.

### Supplementary note 7

The road surface marking deterioration analysis apparatus according to any one of supplementary notes 1 to 6, wherein
the factor determination means determines the factor by using road surface state information indicating a road surface state of the road.

### Supplementary Note 8

The road surface marking deterioration analysis apparatus according to supplementary note 7, wherein
the factor determination means determines the factor, based on the road surface state within a predetermined distance range from a point at which the sensor information is acquired.

### Supplementary Note 9

The road surface marking deterioration analysis apparatus according to any one of supplementary notes 1 to 8, wherein
the factor determination means determines the factor by using at least one of information related to a garbage collection date, and a season.

### Supplementary Note 10

The road surface marking deterioration analysis apparatus according to any one of supplementary notes 1 to 9, wherein
the sensor information includes at least one of a camera image acquired by capturing the road, and three-dimensional point cloud data of the road.

### Supplementary Note 11

The road surface marking deterioration analysis apparatus according to any one of supplementary notes 1 to 10, wherein
the interruption detection means compares a detection result of the road surface marking with at least one of a construction record of construction on the road, inspection data of the road, and a detection result of the road surface marking in a past, and thereby detects a portion where the road surface marking is interrupted.

### Supplementary Note 12

A road surface marking deterioration analysis method including: detecting a road surface marking on a road, based on sensor information acquired by sensing a road;
detecting a portion where the road surface marking is interrupted, based on a detection result of the road surface marking: and
determining a factor for which the road surface marking is interrupted with respect to a portion where a matter that the road surface marking is interrupted is detected.

### Supplementary Note 13

A non-transitory computer-readable medium storing a program for causing a computer to execute processing including:
detecting a road surface marking on a road, based on sensor information acquired by sensing a road;
detecting a portion where the road surface marking is interrupted, based on a detection result of the road surface marking; and
determining a factor for which the road surface marking is interrupted with respect to a portion where a matter that the road surface marking is interrupted is detected.

### REFERENCE SIGNS LIST

10 ROAD SURFACE MARKING DETERIORATION ANALYSIS APPARATUS
11 ROAD SURFACE MARKING DETECTION MEANS
12 INTERRUPTION DETECTION MEANS
13 FACTOR DETERMINATION MEANS
100 ROAD SURFACE MARKING DETERIORATION ANALYSIS SYSTEM
110 ROAD SURFACE MARKING DETERIORATION ANALYSIS APPARATUS
111 DATA ACQUISITION UNIT
112 ROAD SURFACE MARKING DETECTION UNIT
113 INTERRUPTION DETECTION UNIT
114 FACTOR DETERMINATION UNIT
150 NETWORK
200 MOVING BODY
210 CAMERA
500 COMPUTER APPARATUS
510 CPU
520 STORAGE UNIT
530 ROM
540 RAM
550 COMMUNICATION INTERFACE
560 USER INTERFACE

What is claimed is:

1. A road surface marking deterioration analysis apparatus comprising:
at least one memory storing instructions; and
at least one processor configured to execute the instructions to:
detect a road surface marking on a road, based on sensor information acquired by sensing a road;
detect a portion where the road surface marking is interrupted, based on a detection result of the road surface marking; and
determine a factor for which the road surface marking is interrupted with respect to a portion where a matter that the road surface marking is interrupted is detected.

2. The road surface marking deterioration analysis apparatus according to claim 1, wherein
the at least one processor is configured to execute the instructions to determine whether a factor for which the road surface marking is interrupted is deterioration of the road surface marking or dirt of the road surface marking.

3. The road surface marking deterioration analysis apparatus according to claim 1, wherein
the at least one processor is configured to execute the instructions to determine the factor, based on the sensor information.

4. The road surface marking deterioration analysis apparatus according to claim 1, wherein
the at least one processor is configured to execute the instructions to determine the factor by using at least one of cleaning information of the road, or maintenance information of the road surface marking on the road.

5. The road surface marking deterioration analysis apparatus according to claim 4, wherein
the at least one processor is configured to execute the instructions to:
determine the factor by using cleaning information of the road, and
compare a date when the sensor information is acquired with a date when the road is cleaned, and determine the factor, based on a result of the comparison.

6. The road surface marking deterioration analysis apparatus according to claim 4, wherein
the at least one processor is configured to execute the instructions to:
determine the factor by using maintenance information of the road surface marking, and
compare a date when the sensor information is acquired with a date when the road surface marking is maintained, and determine the factor, based on a result of the comparison.

7. The road surface marking deterioration analysis apparatus according to claim 1, wherein
the at least one processor is configured to execute the instructions to determine the factor by using road surface state information indicating a road surface state of the road.

8. The road surface marking deterioration analysis apparatus according to claim 7, wherein
the at least one processor is configured to execute the instructions to determine the factor, based on the road surface state within a predetermined distance range from a point at which the sensor information is acquired.

9. The road surface marking deterioration analysis apparatus according to claim 1, wherein
the at least one processor is configured to execute the instructions to determine the factor by using at least one of information related to a garbage collection date, or a season.

10. The road surface marking deterioration analysis apparatus according to claim 1, wherein
the sensor information includes at least one of a camera image acquired by capturing the road, or three-dimensional point cloud data of the road.

11. The road surface marking deterioration analysis apparatus according to claim 1, wherein
the at least one processor is configured to execute the instructions to compare a detection result of the road surface marking with at least one of a construction record of construction on the road, inspection data of the road, and a detection result of the road surface marking in a past, and thereby detect a portion where the road surface marking is interrupted.

12. A road surface marking deterioration analysis method comprising:
detecting a road surface marking on a road, based on sensor information acquired by sensing a road;
detecting a portion where the road surface marking is interrupted, based on a detection result of the road surface marking; and
determining a factor for which the road surface marking is interrupted with respect to a portion where a matter that the road surface marking is interrupted is detected.

13. A non-transitory computer-readable medium storing a program for causing a computer to execute processing including:
detecting a road surface marking on a road, based on sensor information acquired by sensing a road;
detecting a portion where the road surface marking is interrupted, based on a detection result of the road surface marking; and
determining a factor for which the road surface marking is interrupted with respect to a portion where a matter that the road surface marking is interrupted is detected.
